(19) United States
(12) Patent Application Publication
(10) Pub. No.: US 2026/0268451 A1
(43) Pub. Date: Sep. 10, 2026

(54) Content and Task-Aware Image Restoration

(71) Applicant: Microsoft Technology Licensing, LLC, Redmond, WA (US)

(72) Inventors: Tianyu DING, Redmond, WA (US); Jiachen JIANG, Columbus, OH (US); Luming LIANG, Redmond, WA (US); Ilya Dmitriyevich ZHARKOV, Niwot, CO (US); Tianyi CHEN, Kenmore, WA (US)

(73) Assignee: Microsoft Technology Licensing, LLC, Redmond, WA (US)

(21) Appl. No.: 19/075,722

(22) Filed: Mar. 10, 2025

(51) Int. Cl. G06T 5/60; G06V 10/764; G06V 10/77; G06V 10/774; G06V 10/82

(52) U.S. Cl. CPC G06T 5/60; G06V 10/764; G06V 10/7715; G06V 10/774; G06T 2207/20081; G06T 2207/20084; G06T 2207/30168; G06V 10/82

(57) ABSTRACT

An image restoration machine-trained model (“model”) removes degradation from an input image that is associated with one or more degradation types. The model has an encoder-decoder framework that includes encoders and decoders. Each encoder and decoder processes feature information in a channel attention operation and a spatial attention operation. The model performs the channel attention operation using at least two different channel attention techniques that consume different amounts of resources. The model performs the spatial attention operation by applying different spatial attention techniques to different types of content in the input image. The feature information passed to the decoders includes degradation information that describes the types degradation in the input image. A training system updates the parameters of the model upon the introduction of a new degradation type by fine-tuning an existing version of the model, rather than training the model from scratch.

### BACKGROUND

Image restoration involves reducing identified degradation in an input image. In some cases, the equipment that captures an image causes the degradation. Alternatively, or in addition, a scene depicted in the image includes characteristics that negatively affect the quality of the image. For example, the presence of rain, haze, low-lighting conditions, and glare can each obscure and degrade the appearance of other content in an image.

A first class of image-processing tools focuses on removing single types of degradation. For example, a low-lighting machine-trained model is dedicated to the single task of brightening an image characterized by low lighting. A noise-reduction machine-trained model attempts to remove Gaussian noise from an input image, and so on. A second class of image tools, referred to in the literature as all-in-one image tools, attempts to remove any of plural types of degradation. For example, a machine-trained model designed to reduce distortions in images captured by a vehicle-borne camera may attempt to remove degradation caused by any of haze, low-lighting conditions, and rain.

All-in-one machine-trained models are more versatile than single-degradation machine-trained models, but efforts to improve these models face significant technical challenges. For example, efforts aimed at improving a model's ability to detect and process one type of degradation often negatively affect the model's ability to detect and process another type of degradation. Further, many existing all-in-one models are resource intensive in nature, making them ill-suited for execution platforms having limited memory and processor resources.

### SUMMARY

According to one illustrative aspect, a technique is described for removing degradation in an image that is associated with one or more degradation types. The technique uses an image restoration machine-trained model (“image restoration model”) that includes an encoder-decoder framework of encoders and decoders arranged in an hourglass configuration. Each encoder and decoder processes feature information in a channel attention operation and a spatial attention operation. The channel attention operation involves measuring relations among feature maps (channels) of the feature information, while the spatial attention operation involves generating a measure of relations among different parts of a spatial structure of the feature information.

According to another illustrative aspect, the encoder-decoder framework performs the channel attention operation using at least two different channel attention machine-trained models (“channel attention models”). The different channel attention models extract different amounts of global context information from the feature information, and consume different respective amounts of memory and processor resources.

According to another illustrative aspect, the encoder-decoder framework performs the spatial attention operation by detecting different types of content in the input image, and then applying different spatial attention machine-trained models (“spatial attention models”) to the different types of content. The different spatial attention models consume different amounts of memory and processor resources. The use of different spatial attention models in this manner renders the technique content aware.

According to another illustrative aspect, the technique includes generating degradation information that describes one or more types of degradation in the input image. The decoders in the encoder-decoder framework consume feature information that is infused with this degradation information, making the technique as a whole content aware.

According to another illustrative aspect, the image restoration model includes parameters produced, in a first phase, by training the image restoration model for a first subset of degradation types, to produce a first version of the image restoration model. In second phase, the technique fine-tunes parameters of the first version of the image restoration model for an additional second degradation type not included in the first subset of degradation types. The fine-tuning operation avoids the task of generating an updated image restoration model from scratch when a new degradation type is introduced into the set of degradation types. Fine-tuning is more time-efficient and resource-efficient than training a model from scratch.

Among other technical merits, the image restoration model provides output images having superior quality compared to other all-in-one image restoration models. The image restoration model is also more resource efficient compared to other all-in-one image restoration models. Considered as a whole, the technique provides a way of balancing quality and efficiency that is superior to other all-in-one image restoration models.

The above-summarized technology can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows an image restoration system for reducing degradation in an input image. The image restoration system includes an encoder-decoder framework having a sequence of plural encoders and decoders.

FIG. 2 shows a model structure of each encoder and decoder in the encoder-decoder framework.

FIG. 3 shows a first type of channel attention machine-trained model for use in the encoder-decoder framework.

FIG. 4 shows a second, more resource intensive, type of channel attention machine-trained model for use in the encoder-decoder framework.

FIG. 5 shows one implementation of a spatial attention machine-attention machine-trained model which applies different spatial attention sub-models to different types of content detected in the input image.

FIG. 6 shows overlapping windows used to represent key (K) and value (V) information in performing the spatial attention operation on spatially complex regions of the input image.

FIG. 7 shows a degradation-adapting system for generating and applying degradation information. The degradation information describes the types of degradation that are present in the input image.

FIG. 8 shows functionality for handling the aspect of the degradation-adapting system of FIG. 7 that generates the degradation information for a particular degradation type.

FIG. 9 shows functionality for handling the aspect of the degradation-adapting system of FIG. 7 that applies the degradation information.

FIG. 10 shows a training system for training an image restoration machine-trained model used by the image restoration system of FIG. 1.

FIG. 11 is a table that compares the performance of the image restoration system of FIG. 1 with the performance of other image-processing techniques.

FIG. 12 is a graph that compares the performance and resource efficiency of the image restoration system of FIG. 1 with the performance and efficiency of other image-processing techniques.

FIG. 13 is a table that shows the performance of different versions of the image restoration machine-trained model trained by different respective techniques.

FIG. 14 is a flowchart that provides an overview of one manner of operation of the image restoration system of FIG. 1.

FIG. 15 is a flowchart that provides an overview the operation of the training system of FIG. 10.

FIG. 16 shows computing equipment that, in some implementations, is used to implement the image restoration system of FIG. 1 and the training system of FIG. 10.

FIG. 17 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. Overview of the Image Restoration System

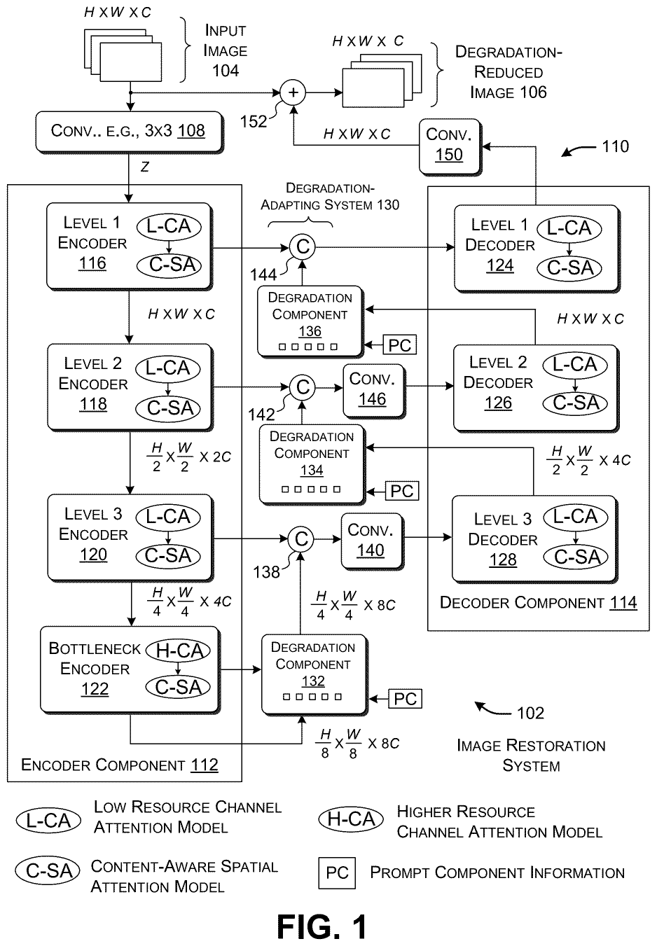

FIG. 1 shows an image restoration system 102 for reducing degradation in an input image. The image restoration system 102 is instantiated by parameters of an image restoration machine-trained model (“image restoration model”). Overall, the image restoration system 102 transforms an input image 104 having one or more forms of degradation to a degradation-reduced image 106. The degradation-reduced image 106 is a version of the input image 104 having reduced presence of the degradation(s) that appear in the input image 104. For example, various implementations of the image restoration system 102 are capable of removing any combination of degradation caused by haze, rain, low-lighting conditions, blur, and Gaussian noise of various kinds (associated with different respective standard deviations, σ). As further explained in Section E, the image restoration model is extensible in the sense that it can be fine-tuned to detect additional degradation types. Fine-tuning avoids the more time-intensive and resource-intensive task of retraining the parameters of the image restoration model from scratch.

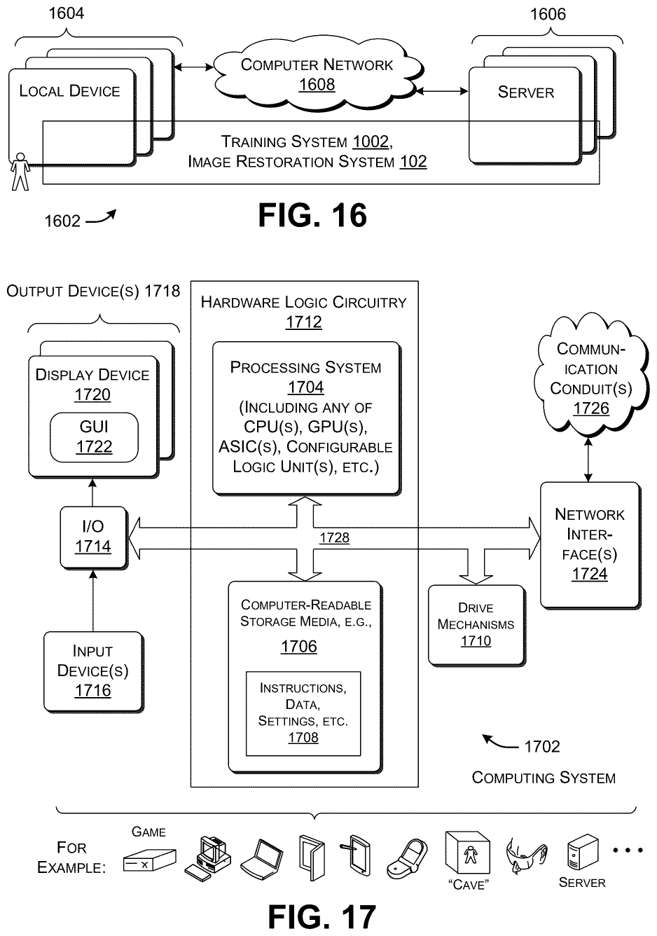

The image restoration system 102 will be described below in generally a top-down manner. The following terminology is relevant to some examples presented below. A “machine-trained model” or “model” refers to computer-implemented logic for executing a task using machine-trained parameters that are produced in a training operation. A “parameter” refers to any type of value that is iteratively produced by the training operation, such as a filter weight parameter or bias value. In some contexts, terms such as “component,” “module,” “engine,” and “tool” refer to parts of computer-based technology that perform respective functions. FIGS. 16 and 17, described below, provide examples of illustrative computing equipment for performing these functions.

In some examples, the input image 104 includes red (R), green (G), and blue (B) components. A convolution component 108 transforms the input image 104 into feature information Z having an initial size of H (for height), W (for width), and C (for the number of channels). A channel of the feature information also constitutes a feature map of the feature information. In some examples, the convolution component 108 is implemented as a 3×3 convolution operation, which involves moving a kernel of size 3×3 pixels across the feature maps.

An encoder-decoder framework 110 includes an encoder component 112 and a decoder component 114 having individual encoders (116, 118, 120, and 122) and decoders (124, 126, 128) arranged in an hourglass configuration. The encoders (116, 118, 120, and 122) successively reduce the resolution of the feature information by performing down-sampling, while the decoders (124, 126, 126) successively increase the resolution of the feature information by performing up-sampling. A bottleneck encoder 122 is the last encoder in the encoder component 112. Other implementations of the encoder-decoder framework 110 include additional (or fewer) encoders and decoders. Further, although not shown, any encoder and decoder at any level can represent a single encoder/decoder block (e.g., one transformer block) or a series of plural encoder/decoder blocks (e.g., plural transformer blocks).

In the example of FIG. 1, the encoder component 112 successively down-samples the input feature information having a size of H×W×C to feature information of size H×W×C at a first level, feature information of size

$$\frac{H}{2} \times \frac{W}{2} \times 2 C$$

at a second level, feature information of size

$$\frac{H}{4} \times \frac{W}{4} \times 4 C$$

at a third level, and feature information of size

$$\frac{H}{8} \times \frac{W}{8} \times 8 C$$

at the bottleneck level. FIG. 1 also shows that feature information is copied between encoders and decoders at respective levels via skip connections, described further below.

A degradation-adapting system 130 detects the type(s) of degradation present at various levels of the encoder-decoder framework 110 using level-specific degradation components (132, 134, 136). For example, the degradation component 132 detects and encodes the type(s) degradation present in the feature information produced by the bottleneck encoder 122, to produce degradation-infused feature information. A combination component 138 (e.g., a concatenation component) combines the degradation-infused feature information with feature information produced by the level-3 encoder 120. The combined feature information is then transformed by a convolution component 140 (e.g., a 1×1 point-wise convolution operation), the output of which is passed to the level-3 decoder 128. This process is repeated for the second layer and the first layer using the level-specific degradation components (134, 136), level-specific combination components (142, 144), and level-specific convolution component 146. FIG. 1 also shows that each degradation component receives prompt component information (PC). This information constitutes machine-trained parameters that influence the operation of a degradation component. Additional information regarding the operation of the degradation-adapting system 130 is set forth below in Section D.

The feature information produced by the top-level decoder 124 is converted back to image information using a convolution component 150 (e.g., a 3×3 convolution operation), and a summation component 152 combines the resultant information with the original input image 104, to produce the degradation reduced image 106.

FIG. 1 shows that each individual encoder and decoder performs two types of attention operations. In a channel attention (CA) operation, a particular encoder/decoder determines the relations among feature maps of the feature information provided to the encoder/decoder. This attention operation can also be viewed as a depth-wise operation insofar as the different feature maps are associated with different channels in a stack of channels of the feature information. The channel attention operation is effective in capturing global context information from the input image 104. In a spatial attention (SA) operation, a particular encoder/decoder determines the relations among parts of a spatial structure associated with the feature information. Spatial attention provides information regarding the importance of different spatial parts of the input image.

From a more general standpoint, the global context information captured by the channel attention operation captures more encompassing dependencies in the feature information compared to the local information captured by the spatial attention operation. For example, with respect to an object that appears in the input image 104, the global context may describe the semantic characteristics of the object, while the local information may describe low-level detail associated with the object, such as edges associated with the object.

The encoder-decoder framework 110 includes at least two channel-attention machine-trained models (“channel-attention models”) for performing the channel attention level, which are used at different levels of the encoder-decoder framework 110. FIG. 1 specifically shows an example in which the attention operation of the bottleneck encoder 122 uses a higher-resource channel attention model (H-CA), while each of the other encoders and decoders uses a low-resource channel attention model (L-CA).

The justification for using different types of channel attention models is as follows. The feature information processed by shallow-level encoders and decoder can be expected to convey mostly local detail compared to global context information. The amount of global context information grows for successively deeper layers of the encoder-decoder framework 110. The encoder-decoder framework 110 accordingly uses a channel attention model at deeper levels of the encoder-decoder framework 110 that is designed to extract global context information from the feature information in a robust way. This channel attention model makes use of a first amount of memory and processor resources. In contrast, the encoder-decoder framework 110 uses a less complex channel attention model at shallower levels. This less complex channel attention model makes use of a second amount of memory and processor resources that is smaller than the first amount. In the examples to follow in Section B, the higher-resource channel attention model uses a computation-intensive self-attention operation, while the low-resource channel attention model uses less data-intensive forms of attention processing compared to self-attention. Further note that, in the example of FIG. 1, only the bottleneck encoder 122 uses the higher-resource channel attention model. In other implementations, however, additional deep layers of the encoder-decoder framework 110 include the higher-resource channel attention model, such as the encoder 120 and decoder 128 at the third level.

Each encoder and decoder use a spatial attention machine-trained model (“spatial attention model”) to perform the spatial attention model. The symbol “C” in the label (C-SA) indicates that the spatial attention model is content aware. This means that the spatial attention model processes regions of feature information in different ways depending on the types of content in those regions. In some examples, the spatial attention model identifies a first subset of patches that includes the most spatially complex parts of an instance of feature information. A second subset of patches includes the remaining patches in the feature information. The spatial attention model uses a first spatial attention sub-model to process the first subset of patches and a second spatial attention sub-model to process the second subset of patches. The first spatial attention sub-model is more effective in identifying relations among details in the feature information compared to the second spatial attention sub-model, but is more resource-intensive than the second spatial attention sub-model. In the examples set forth in Section C, the first spatial attention sub-model uses self-attention to identify relations, while the second spatial attention uses convolution operations to identify relations. The use of a content-aware spatial attention model enables the image restoration system 102 to selectively apply complex spatial analysis to only those regions of the feature information that require it, which has the overall effect of reducing the use of memory and processor resources (compared to the case of using complex spatial analysis for the entirety of the feature information).

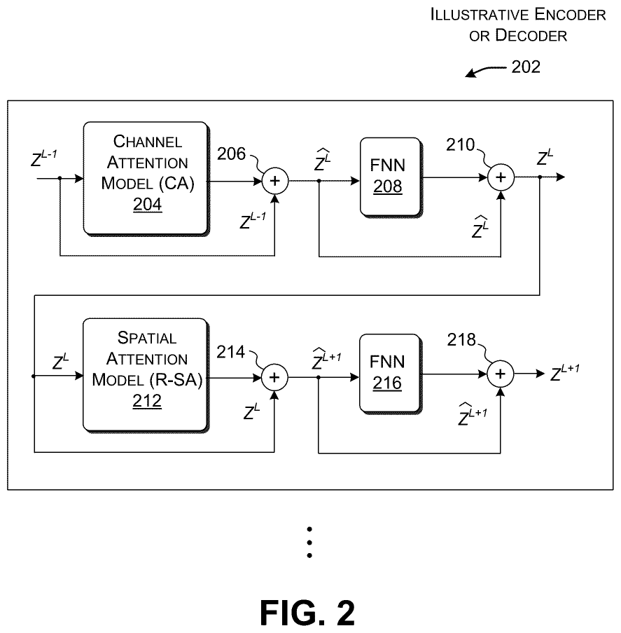

FIG. 2 shows one illustrative implementation encoder or decoder 202. A channel attention model 204 maps input feature information Z^{L-1} provided by a previous layer to output feature information. A summing component 206 combines the output feature information with the input feature information Z^{L-1} to produce feature information \hat{Z}^{L}. A feed forward neural network (FNN) 208 maps the feature information \hat{Z}^{L} to output feature information. A summing component 210 combines the output feature information with the feature information \hat{Z}^{L}, to produce feature information Z^{L}.

A spatial attention model 212 maps input feature information Z^{L} provided to output feature information. A summing component 214 combines the output feature information with the input feature information Z^{L} to produce feature information \hat{Z}^{L+1}. A feed forward neural network (FNN) 216 maps the feature information \hat{Z}^{L+1} to output feature information. A summing component 218 combines the output feature information with the feature information \hat{Z}^{L+1}, to produce feature information Z^{L}.

The operations described above can be mathematically represented as:

$$\{ \begin{matrix}{\hat{Z}}^{L} = ChannelAttn ( {Z}^{L - 1} ) + {Z}^{L - 1} \\ {Z}^{L} = FNN ( {\hat{Z}}^{L} ) + {\hat{Z}}^{L} \\ {\hat{Z}}^{L + 1} = SpatialAttn ( {Z}^{L} ) + {Z}^{L} \\ {Z}^{L + 1} = FNN ( {\hat{Z}}^{L + 1} ) + {\hat{Z}}^{L + 1}\end{matrix} . \qquad ( 1 )$$

ChannelAttn represents the channel attention operation, SpatialAttn represents the spatial attention operation, and FNN represents the feed forward networks (208, 216).

### B. Channel Attention Models

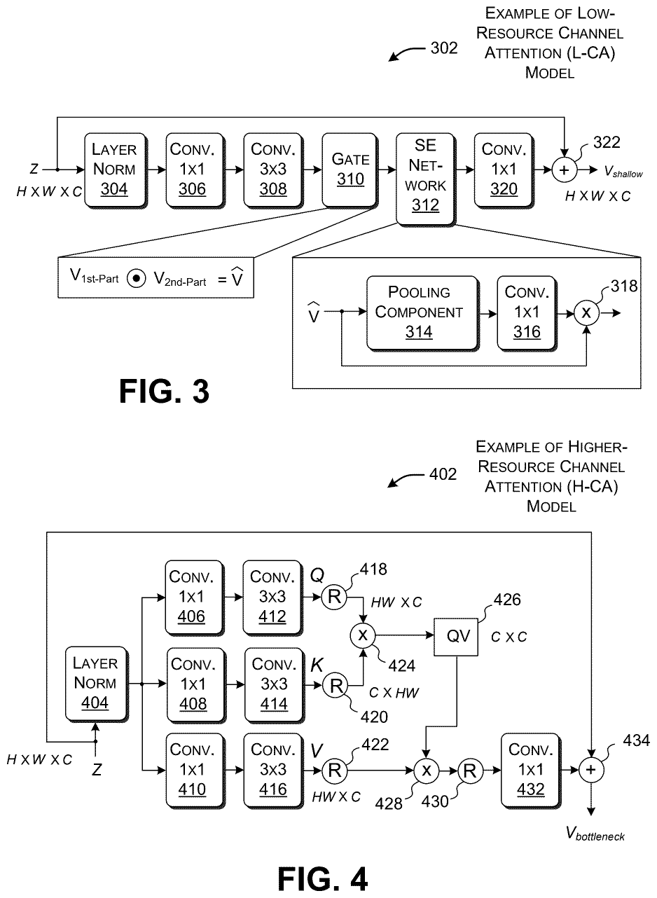

FIG. 3 shows a low-resource channel attention (L-CA) model 302 that is used, in the example of FIG. 1, in all but the bottleneck encoder 122. From left to right, a layer normalization component 304 performs layer normalization on input feature information. A convolution component 306 performs point-wise (1×1) convolution, followed a convolution component 308 that performs depth-wise (3×3) convolution to capture context information. These operations yield feature information V. The operations of this part of the channel attention module 302 are mathematically represented as V=W_{d}WₚLN(Z), where Wₚ and W_{d} represent the point-wise and depth-wise convolution operations, and LN(Z) represents the layer normalization operation.

A gate 310 performs gated nonlinearity operations on the feature information V, to produce feature information \hat{V}. In some implementations, the gate 310 performs this task by performing cross-wise multiplication between split halves of the channel (C/2 each). These operations are mathematically represented as \hat{V}=V_{(1st C/2)} ⊙V_{(2nd C/2)}, where V_{(1st C/2)} represents the first half of the channels in the feature information and V_{(2nd C/2)} represents the second half of the channels in the feature, and ⊙ represents element-wise multiplication of two tensors.

A squeeze-and-excitation (SE) network 312 first uses a pooling component 314 to perform global average pooling (GAP) on the feature information \hat{V}. Global average pooling returns the mean of each feature map. A convolution component 316 performs point-wise (1×1) convolution on the output of the pooling component 314. A multiplication component 318 multiplies the output of the convolution component 316 by \hat{V}. The SE operation is mathematically represented as SE(\hat{V})=\hat{V}WₚGAP(\hat{V}), where GAP(\hat{V}) represents the pooling component 314 and Wₚ represents the convolution component 316. General background information on topic of squeeze-and-excitations networks is found at HU, et al., “Squeeze-and-Excitation Networks,” in Proceedings of the IEEE Conference on Computer Vision and Pattern Recognition, 2018, 10 pages. More generally, the low-resource channel attention model 302 can be implemented by any model that condenses or “squeezes” the spatial information into channel information (e.g., via a pooling layer), followed by post-processing layers that compute channel attention based on the channel information, which reveals the most important features in the feature information.

Another convolution component 320 performs point-wise (1×1) convolution on the output of the SE network 312. A summation component 322 sums the output of the convolution component 320 with the input feature information Z, to produce output feature information (V_{shallow}). These operations are mathematically represented by V_{shallow}=WₚSE(\hat{V})+Z.

FIG. 4 shows a higher-resource channel attention (H-CA) model 402 that is used in the bottleneck encoder 122 (although other implementations can expand its use to other encoders and decoders). “Higher-resource” means that the channel attention model 402 consumes more memory and processor resources compared to the low-resource channel attention model 302 of FIG. 3.

From left to right, a layer normalization component 404 performs layer normalization on input feature information Z. The channel attention model 402 then produces query (Q), key (K), and value (V) projections by performing point-wise convolution operations (1×1) followed by depth-wise (3×3) convolution operations. Convolution components (406, 408, and 410) carry out the point-wise convolution operations, while convolution components (412, 414, and 416) carry out the depth-wise convolution operations. Reshaping components (418, 420, 422) respectively reshape the query (Q), key (K), and value (V) projections by flattening their spatial dimensions, yielding a reshaped query projection \hat{Q} having dimensions HW×C, a reshaped key projection \hat{K} having dimensions C×HW, and a reshaped value projection \hat{V} having dimensions HW×C. A dot product component 424 computes the dot product of \hat{Q} and \hat{K}, to yield attention information 426 having dimensions C×C. A multiplication component 428 multiples the attention information 426 by the reshaped value projection \hat{V}, to complete the attention operation, Attn(\hat{Q}, \hat{K}, \hat{V}).

A reshaping component 430 reshapes the output of the attention operation, follow by a convolution component 432 that performs point-wise convolution (1×1). A summation component 434 adds the output of the convolution component 432 to the input feature information, to yield feature information V_{bottleneck}. This last series of operations is mathematically represented as V_{bottleneck}=WₚAttn(\hat{Q}, \hat{K}, \hat{V})+Z, where Wₚ again represents point-wise convolution. The attention operation itself is mathematically represented by:

$$( \hat{Q} , \hat{K} , \hat{V} ) = \hat{V} Softmax ( \frac{{\hat{Q}}^{T} \cdot \hat{K}}{α} ) . \qquad ( 2 )$$

Softmax represents a normalized exponential function, the subscript T represents transposition, and α represents a learnable scaling parameter. \hat{Q}^{T}·\hat{K} represents the dot product of \hat{Q}^{T} and \hat{K}. Information regarding the general concept of attention in transformer-based neural networks can be found in Vaswani, et al., “Attention Is All You Need,” in 31st Conference on Neural Information Processing Systems (NIPS 2017), 2017, 11 pages.

The use of the attention operation Attn(\hat{Q}, \hat{K}, \hat{V}) improves the ability of the higher-resource channel attention model 402 to capture global context information, but consumes more memory and processor resources than the low-resource channel attention model 302. Overall, by using different types of channel attention models (302, 402) across different layers, the encoder-decoder framework 110 effectively balances quality with efficiency.

Other implementations apply other neural networks to implement low-resource and higher-resource channel attention models, drawing from any combination of neural network components, including convolutional networks, self-attention components, gates, feed-forward networks, and so on. In many cases, the low-resource channel attention model implements a simplified approximation of self-attention.

### C. Spatial Attention Model

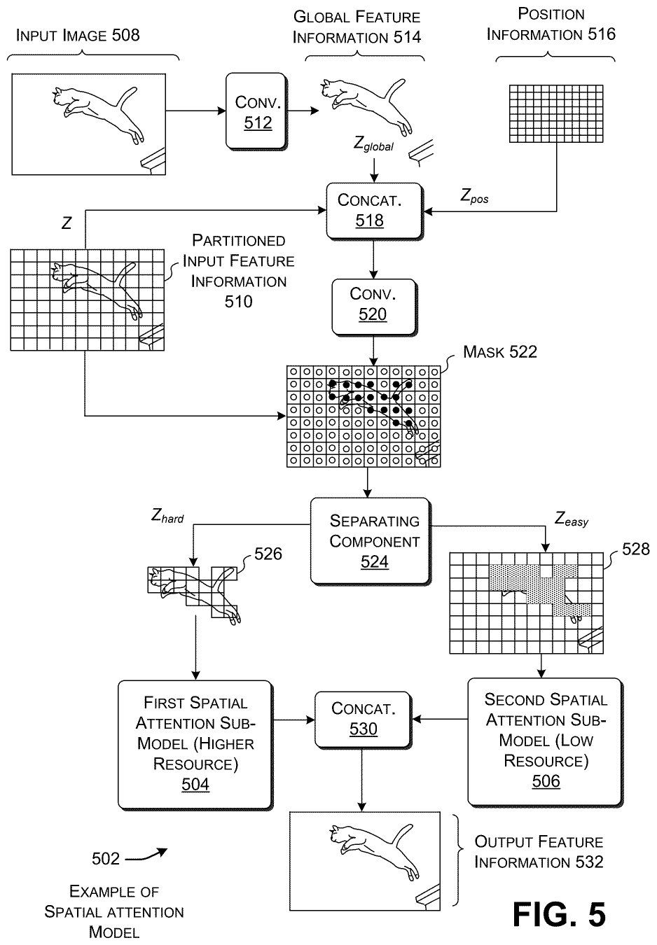

FIG. 5 shows one implementation of a spatial attention model 502. The spatial attention model 502 applies different spatial attention sub-models (504, 506) to different types of content detected in an input image 508. For this reason, the spatial attention model 502 is said to be content aware.

As a first operation, the spatial attention model 502 identifies the types of content present in the input image 508. Assume that this particular input image 508 shows a jumping cat against a mostly mono-color blue sky background. The input image 508 has an overall dimension of H×W. A partitioning component (not shown) partitions a feature map Z of the input image 508 into q×q patches, where q describes the height and width of each patch. This produces a partitioned feature map 510. A convolution component 512 maps the input image 508 into global feature information 514, Z_{global}. A position-generating component (not shown) also generates position embedding information 516 (Zₚₒₛ) that describes locations in the input image 508. For example, the position-generating component expresses information about a position (h, w) in the input image 508 using Zₚₒₛ[h, w]=(2 h/H−1, 2w/W−1).

A concatenation component 518 first concatenates Z, Z_{global}, and Zₚₒₛ. A convolution component 520 performs a convolution operation (e.g., a 3×3 convolution operation) on the concatenated result, which yields a mask 522, M. These operations are mathematically expressed as M=Conv(Concat(Z, Z_{global}, Zₚₒₛ)).

At inference time, a separating component 524 sorts the weights in the mask M to identify a prescribed number of highest value weights, corresponding to those patches that are likely to express the most complex spatial content in the input image 508. In some implementations, the prescribed number of patches is given by γHW/q², where γ is a fixed configuration parameter. As a result, the separating component 524 produces a first subset of hard patches and a second subset of easy patches. Z_{hard} refers to the feature map associated with the first subset of patches. Z_{easy} represents a feature 528 map associated with the second subset of remaining patches in the input image 508.

The first spatial attention sub-model 504 operates on Z_{hard} to produce first feature information, V_{hard}. The second spatial attention sub-model 506 operates on Z_{easy} to produce a second feature information, V_{easy}. A concatenation component 530 concatenates the first feature information with the second feature information to produce final feature information 532, Zₒᵤₜ, which is reshaped to match the original dimensions (H×W×C) of Z.

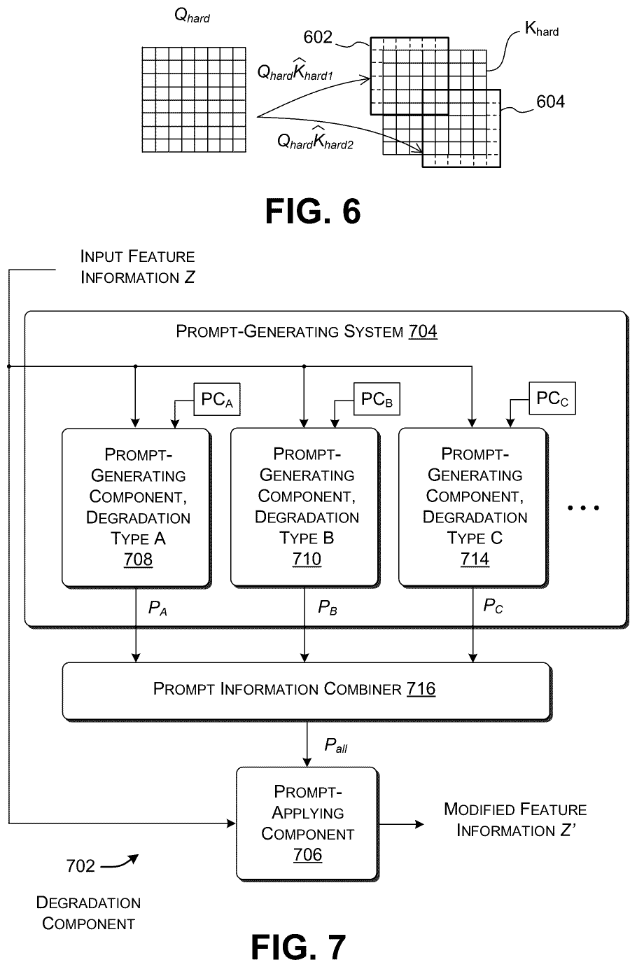

In some implementations, the first spatial attention sub-model 504 applies a self-attention operation to Z_{hard}. As a first step, the first spatial attention sub-model 504 maps Z_{hard} into a query projection Q_{hard}, a key projection K_{hard}, and a value projection V_{hard} via linear projections. The first spatial attention sub-model 504 also expands K_{hard} and V_{hard} by generating overlapping patches. FIG. 6 shows two such overlapping patches (602, 604) formed from K_{hard}, governed by an overlapping ratio τ>1. Each such patch drawn from K_{hard} is denoted as \hat{K}_{hard}, and each patch drawn from Vᵥₐₗᵤₑ is denoted as \hat{V}_{hard}. The expansion of K_{hard} and V_{hard} into overlapping patches increases the available context information, allowing the query Q_{hard} to access a broader range of relevant data during the attention operation. The self-attention operation itself is given by:

$${V}_{hard} = {\hat{V}}_{hard} Softmax ( \frac{{Q}_{hard}^{T} \cdot {\hat{K}}_{hard}}{α} ) . \qquad ( 3 )$$

Again, Softmax represents a normalized exponential function, T represents transposition.

$${Q}_{hard}^{T} \cdot {\hat{K}}_{hard}$$

represents the dot product of

$${Q}_{hard}^{T}$$

and \hat{K}_{hard}, and α is a learnable scaling parameter.

The second spatial attention sub-model 506 uses convolution to generate feature information V_{easy} in a less robust but more computationally efficient manner than the self-attention operation used by the first spatial attention sub-model 504. More specifically, in some implementations, the second spatial attention sub-model 506 first applies a linear transformation to Z_{easy}, to produce \hat{V}_{easy}. This transformation is mathematically given by \hat{V}_{easy}=WZ_{easy}, where W represents the linear transformation. A convolution component (not shown) then operates on \hat{V}_{easy} to yield V_{easy}.

Other implementations apply other neural networks to implement the first spatial attention sub-model 504 and the second spatial attention sub-model 506, drawing from any combination of neural network components, including convolutional networks, attention components, gates, feed-forward networks, and so on. In many cases, the low-resource spatial attention model implements a simplified approximation of self-attention.

### D. Degradation-Adapting System

FIG. 7 shows one implementation of a degradation component 702 for use in the degradation-adapting system 130 of FIG. 1. The degradation component 702 performs two operations. First, a prompt-generating system 704 generates prompt information that describes the effects one or more forms of degradation, as present in a particular instance of feature information Z at a particular level in the encoder-decoder framework 110. Then, a prompt-applying component 706 applies the prompt information to the feature information Z, to produce degradation-infused feature information \hat{Z}.

With reference to FIG. 1, consider the role the of the degradation-infused feature information \hat{Z} in the particular degradation component 134. The degradation component 134 operates on feature information generated by the level-3 decoder 128. The degradation-infused feature information \hat{Z} produced by the degradation component is concatenated with the feature information produced by the level-2 encoder 118. This concatenated feature information is passed to the convolution component 146, the output of which is provided to the level-2 decoder 126. By virtue of this series of operation, the feature information that is passed to the level-2 decoder 126 encompasses information about the types of degradation that are present in the feature information, which, in turn, influences how the level-2 decoder 126 processes the feature information. From a broader perspective, the degradation-adapting system 130 renders the image restoration system 102 task aware.

In the particular example of FIG. 7, the prompt-generating system 704 provides prompt information for three different types of degradation, generically labeled as degradation types A, B, and C. For example, the degradation types A, B, and C may correspond to rain, haze, and noise characterized by a particular σ level. A first prompt-generating component 708 generates prompt information P_{A} for degradation type A based on the input feature information Z and machine-trained prompt component information, denoted by PC_{A}, that pertains to degradation type A. Prompt-generating component B 710 and prompt-generating component C 712 perform the same tasks with respect to degradation types B and C. A prompt information combiner 716 combines (e.g., concatenates or sums) the prompt information for the three degradation types, to provide a single representation of degradation Pₐₗₗ.

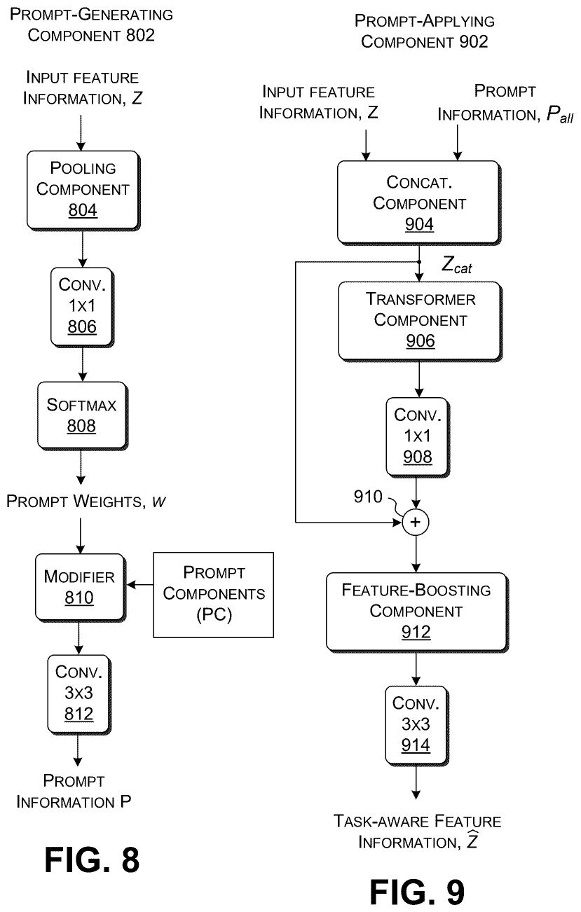

FIG. 8 shows an implementation of a prompt-generating component 802 for a particular degradation type. A pooling component 804 first performs global average pooling (GAP) on the input feature information Z, to produce a vector v with elements that represent the average of each channel in Z. A convolution component 806 downscales the output of the pooling component 804, e.g., using a 1×1 convolution operation. A Softmax component 808 performs a Softmax operation (normalized exponential function) on the output of the convolution component 806, producing a series of weights, each given by w=Softmax(Conv(GAP(Z))). GAP(Z) represents the operation of the pooling component 804 and Conv represents the operation of the convolution component 806. A modifier component 810 multiplies the elements in the machine-learned prompt component information PC by associated weights, and then forms a sum over the channels of these products. A convolution component 812 operates on the output of the modifier component 810 (e.g., using a 3×3 convolution operation), to produce prompt information for the particular degradation type under consideration. This series of operations is mathematically expressed as

$$P = Conv {\sum }_{c = 1}^{N} {w}_{c} {P}_{c} ,$$

wherein Conv represents the operation of the convolution component 812, and the weighted sum represents the operation of the modifier component 810. The symbol c represents a channel in a set of N channels. Note that a training system (not shown) produces an instance of prompt component information for each degradation type. A reshaping component (not shown) reshapes the prompt component information so that it has the same dimensions as the feature information it is to be combined with at a particular level.

FIG. 9 shows a prompt-applying component 902, which is one implementation of the prompt-applying component 706 of FIG. 7. A concatenation component 904 concatenates the input feature information Z with the combined prompt information Pₐₗₗ on a per-channel basis, to produce Z_{cat}. A transformer component 906 performs self-attention across the channels of Z_{cat} using Attn(Q,K,V)=Softmax(K·Q/α)V. Q, K, and V are projections of P_{cat}, produced in the same manner shown in FIG. 4.

A convolution component 908 performs a 1×1 point-wise convolution operation on the output of the transformer component 906, and a summation component 910 combines the output of the convolution component 908 with P_{cat}. A feature-boosting component 912 operates on the output of the summation component 910 to emphasize the most informative features in the feature information provided by the summation component 910. In some implementations, the information-boosting component 912 produces an output Y given by:

$$y = {W}_{p}^{0} ( ϕ ( {W}_{d}^{1} {W}_{p}^{1} ( LN ( X ) ) ) ⊙ ( {W}_{d}^{2} {W}_{p}^{2} ) ( LN ( X ) ) ) + X . \qquad ( 4 )$$

In this equation, X represents the output of the summation component 910,

$${W}_{p}^{.}$$

represents point-wise convolution (e.g., a 1×1 convolution operation),

$${W}_{d}^{.}$$

represents depth-wise convolution (e.g., a 3×3 convolution operation), ⊙ is element-wise multiplication, and φ refers to a non-linear activation function. A convolution component 914 performs a convolution operation (e.g., a 3×3 convolution operation), to produced degradation-infused feature information \hat{Z}.

### E. Training System

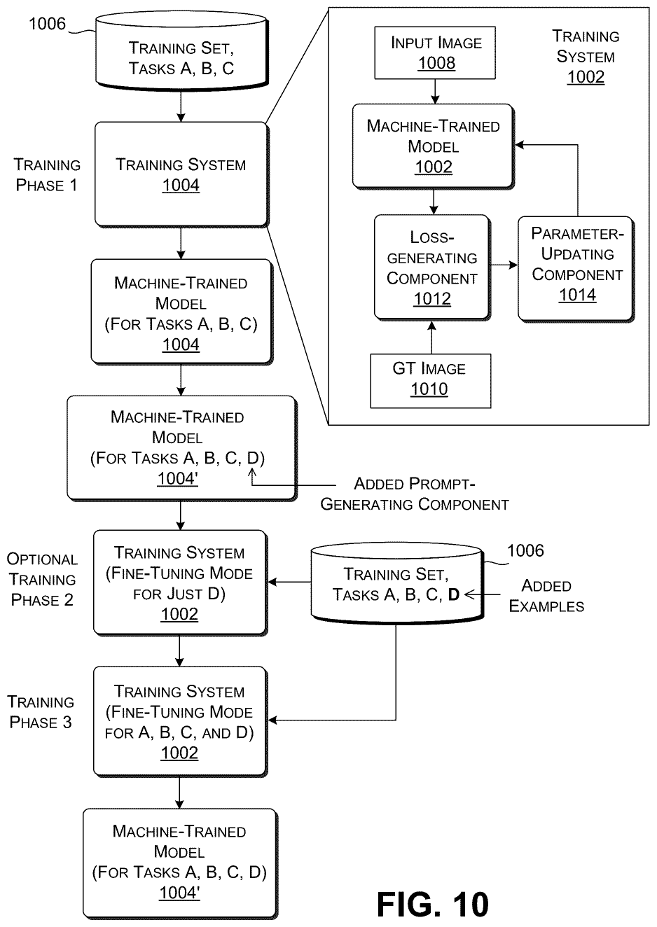

FIG. 10 shows a training system 1002 for training an image restoration machine-trained model 1004 used by the image restoration system 102 of FIG. 1. More specifically, FIG. 10 shows an example in which the training system 1002 produces a first version of the machine-trained model 1004 in a first training phase based on training examples in a data store 1006. The training system 1002 performs this training in a single-stage end-to-end manner. Assume that the first phase specifically trains a machine-trained model 1004 that is capable of handling degradation types A, B, and C (e.g., rain, haze, and blur). The training set will accordingly include examples that pertain to these degradation types. More specifically, assume that each training example includes a degraded input image and its degradation-reduced counterpart image. The degraded image can be artificially produced by adding degradation to a “clean” original image.

In a subsequent training phase, the training system 1002 fine-tunes the first version of the machine-trained model 1004 to also handle a fourth degradation type D, such as low-lighting conditions, to produce a fine-tuned machine-trained model 1004′. A developer sets up this task by adding a new prompt-generating component to the prompt-generating system 704 for degradation type D. The new prompt-generating component operates on an instance of prompt component information PC_{D}, which, at this stage, may be assigned an initial default value. The developer also expands the training example in the data store 1006 to include examples directed to degradation type D. In some cases, the developer may also remove some examples from the data store 1006 pertaining existing degradation types (A, B, and C).

Different implementations are capable of performing the fine-tuning in different respective ways. In one approach, the training system 1002 fine-tunes all of the parameters of the machine-trained model 1004 and instances of prompt component information, but using a learning rate for the new prompt-generating component and its associated instance of prompt component information (PC_{D}) that is higher than a learning rate used for the other parameters of the machine-trained model. This will ensure that the training system 1002 applies the most effort in learning the new parts of the machine-trained model 1004′. This happens in phase 3 shown in FIG. 10.

In another approach, the training system 1002 only updates the new prompt-generating component and its associated instance of prompt component information PC_{D}, freezing the parameter values for the prompt-generating components and instances of prompt component information for the other degradation types. This occurs in the second phase shown in FIG. 3. The training system 1002 then performs the third-phase training as described above.

Generally, the use of a fine-tuning to handle the addition of a new task is desirable because it enables the training system 1002 to more quickly and efficiently converge on a desired state (e.g., with fewer training epochs), compared to the case of retraining all of the parameters of the machine-trained model 1004 from scratch upon the introduction of a new task. The next section will include experimental results that indicate that fine-tuning does not markedly degrade the performance of the machine-trained model 1004 with respect to existing tasks.

FIG. 10 also shows an example of a training operation performed by the training system 1002 with respect to a particular degraded input image 1008 and its degradation-reduced counterpart. The machine-trained model 1004 in its current state of training maps the input image 1008 to a model-generated image. A loss-generating component 1012 determines a measure of loss by comparing the model-generated image with the ground-truth image 1010. A parameter-updating component 1014 updates the trainable parameters of the machine-trained model 1004 based on the loss, e.g., using stochastic gradient descent in combination with back propagation. In actual practice, the training system 1002 may perform the above operations in parallel for a batch of training examples. The training system 1002 continues its training until a desired training objective is achieved.

In some examples, the parameter-updating component 1014 applies Exponential Moving Average (EMA) to update model parameters θ, as given by θ_{EMA}=θ_{EMA}·θ+ (1−β), where β is set of 0.999 in one implementation.

In some examples, the loss-generating component 1012 computes loss (Loss) for a batch of N training examples using the following equation, where

$${I}_{D}^{( i )} and {I}_{GT}^{( i )}$$

represent one particular input image and ground-truth image in the batch, respectively:

$$Loss = \frac{1}{N} {\sum }_{i = 1}^{N} {‖ {I}_{GT}^{( i )} - Model ( {I}_{D}^{( i )} ) ‖}_{1} + {( \frac{1}{J} {\sum }_{j = 1}^{J} {γ}_{j} - {γ}_{0} )}^{2} . \qquad ( 5 )$$

The first part of the loss equation sums the L1 differences between model-generated images and ground-truth images, and divides the sum by the number of training examples N.

$$Model ( {I}_{D}^{( i )} )$$

represents an individual model-generated image. The optional second part of the loss equation is a regularization term that serves to align block ratios for individual processing blocks in the machine-trained model 1004 with a target block ratio γ₀. There are J such processing blocks, with γⱼ being a current block ratio for a jth processing block. That is, in those examples in which sparsification is used (which involves dropping the least significant tokens at various stages of a model to improve processing efficiency), a block ratio controls the percentage of tokens that are retained in a particular block of the machined-trained model 1004.

Finally, the training system 1002 can approximate the partitioning of feature information Z into hard feature information and easy feature information using a Gumbel-Softmax operator. This operator is differentiable (whereas the inference-time selection mechanism is not), and therefore accommodates the updating of weights performed by the parameter-updating component 1014. General background information regarding the use of the Gumbel-Softmax operator can be found in JANG, et al., Categorical Reparameterization with Gumbel-Softmax,” arXiv, arXiv:1611.01144v5 [stat.ML], Aug. 5, 2017, 13 pages.

### F. Experimental Results

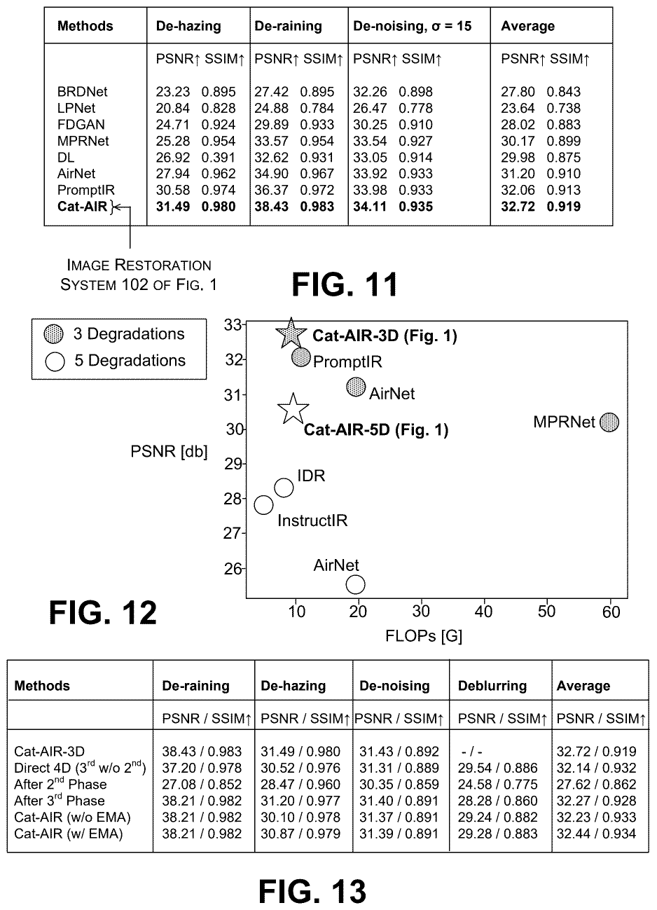

FIG. 11 is a table that compares the performance of the image restoration system 102 of FIG. 1 with the performance of other image-processing techniques. That is, the table refers to the image restoration system 102 as Cat-AIR. Assume that the image restoration system 102 includes a four-level encoder-decoder framework 110, the first level having two transformer blocks, and remaining levels including four transformer blocks each. The target mask ratio is set to γ0=0.5, and the attention operations are performed with respect to attention windows of size 8×8. Training occurs over 120 epochs with a batch size of 16 examples.

The other referenced machine-trained systems correspond to: 1) BRDNet, described in Tian, et al., “Image denoising using deep CNN with batch renormalization,” in Neural Networks,” Vol. 121, January 2020, pp. 461-473; (2) LPNet, described in Gao, et al., “Dynamic Scene Deblurring with Parameter Selective Sharing and Nested Skip Connections,” in Proceedings of the IEEE/CVF Conference on Computer Vision and Pattern Recognition, 2019; (3) FDGAN, described in Dong, et al., “FD-GAN: Generative Adversarial Networks with Fusion-Discriminator for Single Image Dehazing,” in Proceedings of the AAAI Conference on Artificial Intelligence, 2020, 8 pages; (4) MPRNet, described in Zamir, et al., “Multi-Stage Progressive Image Restoration,” in 2021 IEEE/CVF Conference on Computer Vision and Pattern Recognition (CVPR), 2021, 11 pages; (5) DL, described in Fan, et al., “A General Decoupled Learning Framework for Parameterized Image Operators,” arXiv: 1907.05852v1 [cs.CV], Jul. 11, 2019, 14 pages; (6) AirNet, described in Li, et al., “All-In-One Image Restoration for Unknown Corruption,” in IEEE Conference on Computer Vision and Pattern Recognition, 2022, 11 pages; and (7) PromptIR, described Potlapalli, et al., “PromptIR: Prompting for All-in-One Image Restoration,” in 37th Conference on Neural Information Processing Systems (NeurIPS 2023), 2023, 19 pages.

PSNR refers to a peak sign-to-noise measure, while SSIM refers to a structural similarity index measure. As shown in the table, the image restoration system 102 of FIG. 1 achieves superior performance to the other systems, with respect to both PSNR and SSIM for all degradation types (here, de-hazing, de-raining, and de-noising with respect to a σ of 15).

FIG. 12 is a graph that compares the performance and resource efficiency of the image restoration system 102 of FIG. 1 with respect to other image-processing systems. Cat-AIR again refers to the image restoration system 102 of FIG. 1. InstructIR refers to the system described in Conde, et al., “InstructIR: High-Quality Image Restoration Following Human Instructions,” in Proceedings of the European Conference on Computer Vision (ECCV), September 2024, 20 pages. IDR, refers to the system described in Zhang, et al., “Ingredient-oriented Multi-Degradation Learning for Image Restoration,” in Proceedings of the IEEE/CVF Conference on Computer Vision and Pattern Recognition, 2023, 10 pages. Other referenced models are identified above with respect to table of FIG. 11.

As shown, the image restoration system 102 of FIG. 1 has the best quality (measured by PSNR) and the best efficiency (as measured by the number of FLOPs) compared to the other systems. This is true for both the case in which the systems are asked to handle three types of degradation and the case in which the systems are asked to handle five types of degradations. Note, however, that the PSNR performance of all systems decreases somewhat when the systems are asked to handle additional degradation types.

FIG. 13 is a table that shows the performance of the machine-trained model 1004 produced by the training system 1002 of FIG. 10 for the case in which the machine-trained model 1004 is initially trained to handle three tasks (de-raining, d-de-hazing, and de-noising), and then fine-tuned to handle an additional task (deblurring), to produce a machine-trained model 1004′. The “Cat-Air-3D” row describes the performance of the machine-trained model 1004 as initially trained on three tasks. The “Direct 4D” row describes the performance of the machined model 1004′ when it is trained on an expanded training set, but without adding a prompt-generating component for the new degradation type. The remaining approaches include the preliminary step of expanding the training set and adding a prompt-generating component for the new degradation type. The “After 2^{nd} Phase” row describes the performance the machine-trained model 1004′ after the second phase of training shown in FIG. 10, and the “After 3^{rd} Phase” row describes the performance of the machine-trained model 1004′ after the second and third phases of training shown in FIG. 10. The “Cat-AIR (w/o EMA)” row describes the performance of the machine-trained model 1004′ in which the “3^{rd} Phase” is performed without the “2^{nd} Phase,” and without using Exponential Moving Average (EMA). The “Cat-AIR (w/EMA)” is the same as “Cat-Air w/o EMA,” except that that EMA is now used. The last three rows of FIG. 13 generally demonstrate that the fine-tuning of FIG. 10 effectively adapts the machine-trained model 1004 to handle additional tasks, without markedly degrading the performance of existing approaches. It is also more time-efficient and resource-efficient compared to training the machine-trained model 1004′ from scratch upon the introduction of a new degradation type. A developer can choose a particular kind of fine-tuning, e.g., among the types described by FIG. 13, based on the environment-specific considerations.

### G. Illustrative Processes

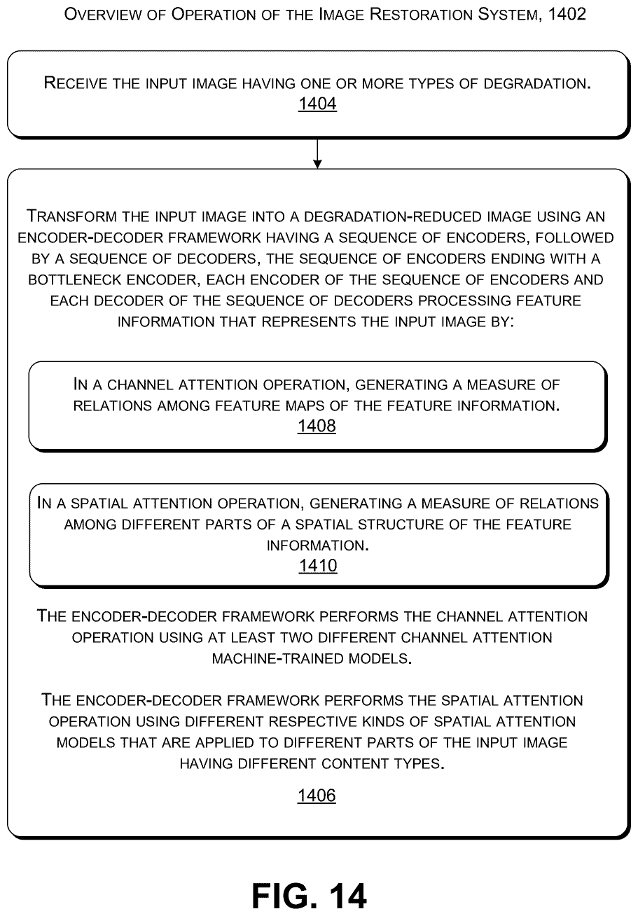

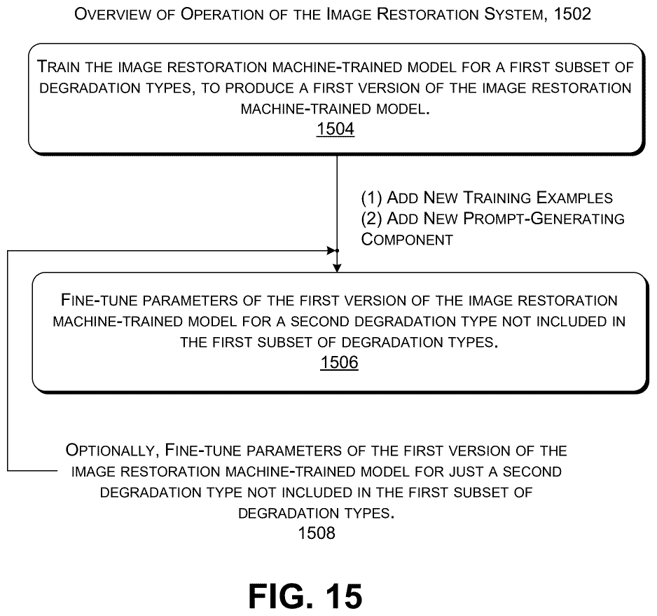

FIGS. 14 and 15 show two processes that represent an overview of the operation of image restoration system 102 and training system 1002 of FIGS. 1 and 10. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 16 and 17.

More specifically, FIG. 14 shows a process 1402 for reducing degradation in an input image (e.g., the input image 104) using an image restoration machine-trained model. In block 1404, the image restoration system 102 receives the input image having one or more types of degradation. In block 1406, the image restoration system 102 transforms the input image into a degradation-reduced image using an encoder-decoder framework (e.g., the encoder-decoder framework 110) having a sequence of encoders (e.g., encoders 116, 118, 120, and 122), followed by a sequence of decoders (e.g., decoders 124, 126, 128), the sequence of encoders ending with a bottleneck encoder.

Each encoder of the sequence of encoders and each decoder of the sequence of decoders processes feature information that represents the input image by: in a channel attention operation, generating (e.g., in block 1408) a measure of relations among feature maps of the feature information; and in a spatial attention operation, generating (e.g., in block 1410) a measure of relations among different parts of a spatial structure of the feature information.

The encoder-decoder framework performs the channel attention operation using at least two different channel attention machine-trained models. The encoder-decoder framework performs the spatial attention operation using different respective kinds of spatial attention models that are applied to different parts of the input image having different content types.

FIG. 15 shows a process 1502 for training an image restoration machine-trained model (e.g., the image restoration machine-trained model 1004). In block 1504, the training system 1002 trains the image restoration machine-trained model for a first subset of degradation types, to produce a first version of the image restoration machine-trained model. In block 1506, the training system 1002 fine-tunes parameters of the first version of the image restoration machine-trained model for a second degradation type not included in the first subset of degradation types. Block 1506 is preceded by adding training examples and a prompt-generating component for the second degradation type. In one implementation, block 1506 is preceded by fine-tuning (e.g., in block 1508) that is performed for just the second degradation type.

### H. Illustrative Computing Equipment

FIG. 16 shows computing equipment 1602 that, in some implementations, is used to implement the image-restoration system 102 and the training system 1002. The computing equipment 1602 includes a set of local devices 1604 coupled to a set of servers 1606 via a computer network 1608. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1608 is implemented as a local area network, a wide area network (e.g., the Internet), one or more point-to-point links, or any combination thereof.

The bottom-most overlapping box in FIG. 16 indicates that the functionality of the image restoration system 102 is capable of being spread across the local devices 1604 and/or the servers 1606 in any manner. In one example, the image restoration system 102 is entirely implemented by a local device. In another example, the functions of the image restoration system 102 are entirely implemented by the servers 1606. Here, a user is able to interact with the servers 1606 via a browser application running on a local device. In other examples, some of the functions of the image restoration system 102 are implemented by a local device, and other functions of the image restoration system 102 are implemented by the servers 1606. The same holds true regarding the implementation of the training system 1002; it can be implemented by local resources, server-side resources, or a combination of local and server-side resources.

FIG. 17 shows a computing system 1702 that, in some implementations, is used to implement any aspect of the mechanisms set forth in the above-described figures. For instance, in some implementations, the type of computing system 1702 shown in FIG. 17 is used to implement any local computing device or any server shown in FIG. 16. In all cases, the computing system 1702 represents a physical and tangible processing mechanism.

The computing system 1702 includes a processing system 1704 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1702 also includes computer-readable storage media 1706, corresponding to one or more computer-readable media hardware units. The computer-readable storage media 1706 retains any kind of information 1708, such as machine-readable instructions, settings, model weights, and/or other data. In some implementations, the computer-readable storage media 1706 includes one or more solid-state devices, one or more hard disks, one or more optical disks, etc. Any instance of the computer-readable storage media 1706 represents a fixed or removable unit of the computing system 1702. Further, any instance of the computer-readable storage media 1706 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1702 utilizes any instance of the computer-readable storage media 1706 in different ways. For example, in some implementations, any instance of the computer-readable storage media 1706 represents a hardware memory unit (such as random access memory (RAM)) for storing information during execution of a program by the computing system 1702, and/or a hardware storage unit (such as a hard disk) for retaining/archiving information on a more permanent basis. In the latter case, the computing system 1702 also includes one or more drive mechanisms 1710 (such as a hard drive mechanism) for storing and retrieving information from an instance of the computer-readable storage media 1706.

In some implementations, the computing system 1702 performs any of the functions described above when the processing system 1704 executes computer-readable instructions stored in any instance of the computer-readable storage media 1706. For instance, in some implementations, the computing system 1702 carries out computer-readable instructions to perform each block of the processes described with reference to FIGS. 14 and 15. FIG. 17 generally indicates that hardware logic circuitry 1712 includes any combination of the processing system 1704 and the computer-readable storage media 1706.

In addition, or alternatively, the processing system 1704 includes one or more other configurable logic units that perform operations using a collection of logic gates, such as field-programmable gate arrays (FPGAs), etc. In these implementations, the processing system 1704 effectively incorporates a storage device that stores computer-readable instructions, insofar as the configurable logic units are configured to execute the instructions and therefore embody or store these instructions.

In some cases (e.g., in the case in which the computing system 1702 represents a user computing device), the computing system 1702 also includes an input/output interface 1714 for receiving various inputs (via input devices 1716), and for providing various outputs (via output devices 1718). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1720 and an associated graphical user interface presentation (GUI) 1722. The display device 1720 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1702 also includes one or more network interfaces 1724 for exchanging data with other devices via one or more communication conduits 1726. One or more communication buses 1728 communicatively couple the above-described units together.

The communication conduit(s) 1726 is implemented in any manner, e.g., by a local area computer network, a wide area computer network (e.g., the Internet), point-to-point connections, or any combination thereof. The communication conduit(s) 1726 include any combination of hardwired links, wireless links, routers, gateway functionality, name servers, etc., governed by any protocol or combination of protocols.

FIG. 17 shows the computing system 1702 as being composed of a discrete collection of separate units. In some cases, the collection of units corresponds to discrete hardware units provided in a computing device chassis having any form factor. FIG. 17 shows illustrative form factors in its bottom portion. In other cases, the computing system 1702 includes a hardware logic unit that integrates the functions of two or more of the units shown in FIG. 17. For instance, in some implementations, the computing system 1702 includes a system on a chip (SoC or SOC), corresponding to an integrated circuit that combines the functions of two or more of the units shown in FIG. 17.

The following summary provides a set of illustrative examples of the technology set forth herein.

(A1) According to one illustrative aspect, a method (e.g., the process 1402) is described for reducing degradation in an input image (e.g., the input image 104) using an image restoration machine-trained model. The method includes receiving (e.g., in block 1404) the input image having one or more types of degradation; and transforming (e.g., in block 1406) the input image into a degradation-reduced image (e.g., the degradation-reduced image 106) using an encoder-decoder framework (e.g., the framework 110) having a sequence of encoders (e.g., encoders 116, 118, 120, and 122), followed by a sequence of decoders (e.g., decoders 124, 126, 128), the sequence of encoders ending with a bottleneck encoder (e.g., bottleneck encoder 128). Each encoder of the sequence of encoders and each decoder of the sequence of decoders processes feature information that represents the input image by: in a channel attention operation, generating (e.g., in block 1408) a measure of relations among feature maps of the feature information; and in a spatial attention operation, generating (e.g., in block 1410) a measure of relations among different parts of a spatial structure of the feature information. The encoder-decoder framework performs the channel attention operation using at least two different channel attention machine-trained models (e.g., channel attention machine-trained models 302, 402). The encoder-decoder framework performs the spatial attention operation using different respective kinds of spatial attention models (e.g., spatial attention sub-models 504, 506) that are applied to different parts of the input image having different content types.

(A2) According to illustrative aspects of A1, the method further includes: generating degradation information that describes the one or more types of degradation in the input image; and integrating the degradation information with instances of feature information processed by the decoders.

(A3) According to illustrative aspects of A2, the generating degradation information includes generating plural instances of the degradation information for respective plural types of degradation.

(A4) According to illustrative aspects of any of A1-A3, the one or more types of degradation include: degradation caused by rain captured by the input image; and/or degradation caused by haze captured by the input image; and/or degradation caused by low-lighting conditions that affect the input image; and/or degradation attributed to blur in the input image; and/or degradation attributed to noise in the input image.

(A5) According to illustrative aspects of any of A1-A4, the at least two different channel attention machine-trained models include: a first type of channel attention machine-trained model that uses self-attention to measure the relations among the feature maps; and a second type of channel attention machine-trained model that condenses the feature information into condensed channel information and then computes the relations among the feature maps based on the condensed channel information.

(A6) According to illustrative aspects of A5, the bottleneck encoder uses the second type of channel attention machine-trained model, and wherein other encoders and decoders use the first type of channel attention machine-trained model.

(A7) According to illustrative aspects of A5 or A6, the first type of channel attention machine-rained model consumes more processing and memory resources compared to the second type of channel attention machine-trained model.

(A8) According to illustrative aspects of any of A1-A7, the different spatial attention machine-trained models include a first spatial attention machine-trained model and a second spatial attention machine-trained model, wherein the spatial attention operation further includes: partitioning the feature information into patches; identifying a first subset of patches that correspond to most spatially complex parts of the input image, and identifying a second subset of patches as remaining patches of the feature information; processing the first subset of patches using the first spatial attention machine-trained model; and processing the second subset of patches using the second spatial attention machine-trained model.

(A9) According to illustrative aspects of A8, the first spatial attention machine-trained model uses self-attention to measure the relations among different parts of the spatial structure of the feature information.

(A10) According to illustrative aspects of A8 or A9, the second spatial attention machine-trained model uses convolution to measure the relations among different parts of the spatial structure of the feature information.

(A11) According to illustrative aspects of any of A1-A10, the image restoration machine-trained model includes parameters that have been produced by: training the image restoration machine-trained model for a first subset of degradation types, to produce a first version of the image restoration machine-trained model; and fine-tuning parameters of the first version of the image restoration machine-trained model for a second degradation type not included in the first subset of degradation types.

(A12) According to illustrative aspects of A11, the fine-tuning is performed for parameters associated with the second degradation type using a learning rate that is higher than a learning rate applied to other parameters of the image restoration machine-trained model.

(A13) According to illustrative aspects of A11 or A12, the fine-tuning that is performed for the first subset of degradation types and the second degradation type is preceded by fine-tuning that is performed for just the second degradation type.

In yet another aspect, some implementations of the technology described herein include a computing system (e.g., the computing system 1702) that includes a processing system (e.g., the processing system 1704) having a processor. The computing system also includes a storage device (e.g., the computer-readable storage media 1706) for storing computer-readable instructions (e.g., the information 1708). The processing system executes the computer-readable instructions to perform any of the methods described herein (e.g., any individual method of the methods of A1-A13).

In yet another aspect, some implementations of the technology described herein include a computer-readable storage medium (e.g., the computer-readable storage media 1706) for storing computer-readable instructions (e.g., the information 1708). A processing system (e.g., the processing system 1704) executes the computer-readable instructions to perform any of the operations described herein (e.g., the operations in any individual method of the methods of A1-A13).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1712 of FIG. 17. The term “logic” likewise encompasses various physical and tangible mechanisms for performing a task. For instance, each processing-related operation illustrated in the flowcharts of FIGS. 14 and 15 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for reducing degradation in an input image using an image restoration machine-trained model, comprising:
receiving the input image having one or more types of degradation;
transforming the input image into a degradation-reduced image using an encoder-decoder framework having a sequence of encoders, followed by a sequence of decoders, the sequence of encoders ending with a bottleneck encoder,
each encoder of the sequence of encoders and each decoder of the sequence of decoders processing feature information that represents the input image by:
in a channel attention operation, generating a measure of relations among feature maps of the feature information; and
in a spatial attention operation, generating a measure of relations among different parts of a spatial structure of the feature information,
wherein the encoder-decoder framework performs the channel attention operation using at least two different channel attention machine-trained models, and
wherein the encoder-decoder framework performs the spatial attention operation using different respective kinds of spatial attention models that are applied to different parts of the input image having different content types.

2. The method of claim 1, wherein the method further includes:
generating degradation information that describes the one or more types of degradation in the input image; and
integrating the degradation information with instances of feature information processed by the decoders.

3. The method of claim 2, wherein the generating degradation information includes generating plural instances of the degradation information for respective plural types of degradation.

4. The method of claim 1, wherein the one or more types of degradation include:
degradation caused by rain captured by the input image; and/or
degradation caused by haze captured by the input image; and/or
degradation caused by low-lighting conditions that affect the input image; and/or
degradation attributed to blur in the input image; and/or
degradation attributed to noise in the input image.

5. The method of claim 1, wherein the at least two different channel attention machine-trained models include:
a first type of channel attention machine-trained model that uses self-attention to measure the relations among the feature maps; and
a second type of channel attention machine-trained model that condenses the feature information into condensed channel information and then computes the relations among the feature maps based on the condensed channel information.

6. The method of claim 5, wherein the bottleneck encoder uses the second type of channel attention machine-trained model, and wherein other encoders and decoders use the first type of channel attention machine-trained model.

7. The method of claim 5, wherein the first type of channel attention machine-rained model consumes more processing and memory resources compared to the second type of channel attention machine-trained model.

8. The method of claim 1, wherein the different spatial attention machine-trained models include a first spatial attention machine-trained model and a second spatial attention machine-trained model, and wherein the spatial attention operation further includes:
partitioning the feature information into patches;
identifying a first subset of patches that correspond to most spatially complex parts of the input image, and identifying a second subset of patches as remaining patches of the feature information;
processing the first subset of patches using the first spatial attention machine-trained model; and
processing the second subset of patches using the second spatial attention machine-trained model.

9. The method of claim 8, wherein the first spatial attention machine-trained model uses self-attention to measure the relations among different parts of the spatial structure of the feature information.

10. The method of claim 8, wherein the second spatial attention machine-trained model uses convolution to measure the relations among different parts of the spatial structure of the feature information.

11. The method of claim 1, wherein the image restoration machine-trained model includes parameters that have been produced by:
training the image restoration machine-trained model for a first subset of degradation types, to produce a first version of the image restoration machine-trained model; and
fine-tuning parameters of the first version of the image restoration machine-trained model for a second degradation type not included in the first subset of degradation types.

12. The method of claim 11, wherein the fine-tuning is performed for parameters associated with the second degradation type using a learning rate that is higher than a learning rate applied to other parameters of the image restoration machine-trained model.

13. The method of claim 11, wherein the fine-tuning that is performed for the first subset of degradation types and the second degradation type is preceded by fine-tuning that is performed for just the second degradation type.

14. A computing system for reducing one or more types of degradation in an input image, comprising:
an instruction data store for storing computer-readable instructions and parameters, the computer-readable instructions and parameters implementing an image restoration machine-trained model,
the image restoration machine-trained model having an encoder-decoder framework that includes a sequence of encoders, followed by a sequence of decoders, the sequence of encoders ending with a bottleneck encoder,
a processing system for executing the image restoration machine-trained model to perform operations on feature information that represents a received input image,
the operations comprising, for each encoder and decoder in the encoder-decoder framework:
in a channel attention operation, generating a measure of relations among feature maps of the feature information; and
in a spatial attention operation, generating a measure of relations among different parts of a spatial structure of the feature information,
wherein the encoders and the decoders use different amounts of resources to perform the channel attention operation, and
wherein the encoders and decoders use different amounts of resources to process different types of image content represented by the feature information.

15. The computing system of claim 14, wherein the operations further include:
generating degradation information that describes the one or more types of degradation in the input image; and
integrating the degradation information with instances of feature information processed by the decoders.

16. The computing system of claim 14,
wherein at least one of the encoders performs the channel attention operation using a first type of channel attention machine-trained model that uses self-attention, and
wherein other of the encoders and decoders perform the channel attention operation by condensing the feature information into condensed channel information and then computing the relations among the feature maps based on the condensed channel information.

17. The computing system of claim 14, wherein the encoders and decoders perform the spatial attention operation by:
partitioning the feature information into patches;
identifying a first subset of patches that correspond to most spatially complex parts of the input image, and identifying a second subset of patches as remaining patches of the feature information;
processing the first subset of patches using a first spatial attention machine-trained model; and
processing the second subset of patches using a second spatial attention machine-trained model.

18. The computing system of claim 17,
wherein the first spatial attention machine-trained model uses self-attention to measure the relations among different parts of the spatial structure of the feature information, and
wherein the second spatial attention machine-trained model uses convolution to measure the relations among different parts of the spatial structure of the feature information.

19. The computing system of claim 14, wherein the image restoration machine-trained model includes parameters that have been produced by:
training the image restoration machine-trained model for a first subset of degradation types, to produce a first version of the image restoration machine-trained model; and
fine-tuning parameters of the first version of the image restoration machine-trained model for a second degradation type not included in the first subset of degradation types.

20. A computer-readable storage medium for storing computer-readable instructions associated with an image restoration machine-trained model, a processing system executing the computer-readable instructions to perform operations, the operations comprising each of:
receiving an input image having one or more types of degradation;
transforming the input image into a degradation-reduced image using an encoder-decoder framework having a sequence of encoders, followed by a sequence of decoders, the sequence of encoders ending with a bottleneck encoder,
each encoder of the sequence of encoders and each decoder of the sequence of decoders processing feature information that represents the input image by:
in a channel attention operation, generating a measure of relations among feature maps of the feature information; and
in a spatial attention operation, generating a measure of relations among different parts of a spatial structure of the feature information,
wherein the image restoration machine-trained model includes weights that have been produced by:
training the image restoration machine-trained model for a first subset of degradation types, to produce a first version of the image restoration machine-trained model; and
fine-tuning parameters of the first version of the image restoration machine-trained model for a second degradation type not included in the first subset of degradation types.
